(19) United States
(12) Patent Application Publication
(10) Pub. No.: US 2014/0294537 A1
(43) Pub. Date: Oct. 2, 2014

(54) FASTENING DEVICE AND FASTERNER FOR FAN

(71) Applicant: HON HAI PRECISION INDUSTRY CO., LTD., New Taipei (TW)

(72) Inventors: CHUN-WEI CHANG, New Taipei (TW); MING-TA YU, New Taipei (TW); CHUN-WEI KUAN, New Taipei (TW)

(73) Assignee: HON HAI PRECISION INDUSTRY CO., LTD., New Taipei (TW)

(21) Appl. No.: 13/873,252

(22) Filed: Apr. 30, 2013

(30) Foreign Application Priority Data
Mar. 29, 2013 (TW) 102111607

(51) Int. Cl. F16B 19/00

(52) U.S. Cl. CPC F16B 19/00
USPC 411/509

(57) ABSTRACT

A fastener includes a resilient head, a position pole extending out from a first end of the head, and a resilient latching portion protruding out from the position pole away from the head. A circumference of the head defines a mounting slot. A second end of the head opposite to the position pole defines an operation hole extending to the position pole.

### BACKGROUND

1. Technical Field

The present disclosure relates to fastening devices, and particularly to a fastening device for a fan.

2. Description of Related Art

Fans are widely used in computer systems for dissipating heat. A number of fans are secured by screws or the like to an enclosure of the computer system. The fans are used for producing airflow to dissipate heat for electronic components within the enclosure, thus keeping the components operating within a desired temperature range. However, the installation of using the screws is time consuming and troublesome.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is an exploded, isometric view of an exemplary embodiment of a fastening device, together with a fan, wherein the fastening device includes a plurality of fasteners.

FIG. 2 is an enlarged view of one of the fasteners of FIG. 1.

FIG. 3 is a sectional view of FIG. 2, taken along the line of III-III.

FIGS. 4-6 are cross-sectional views showing the process of assembling the fan.

FIG. 7 is an assembled view of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references can mean “at least one.”

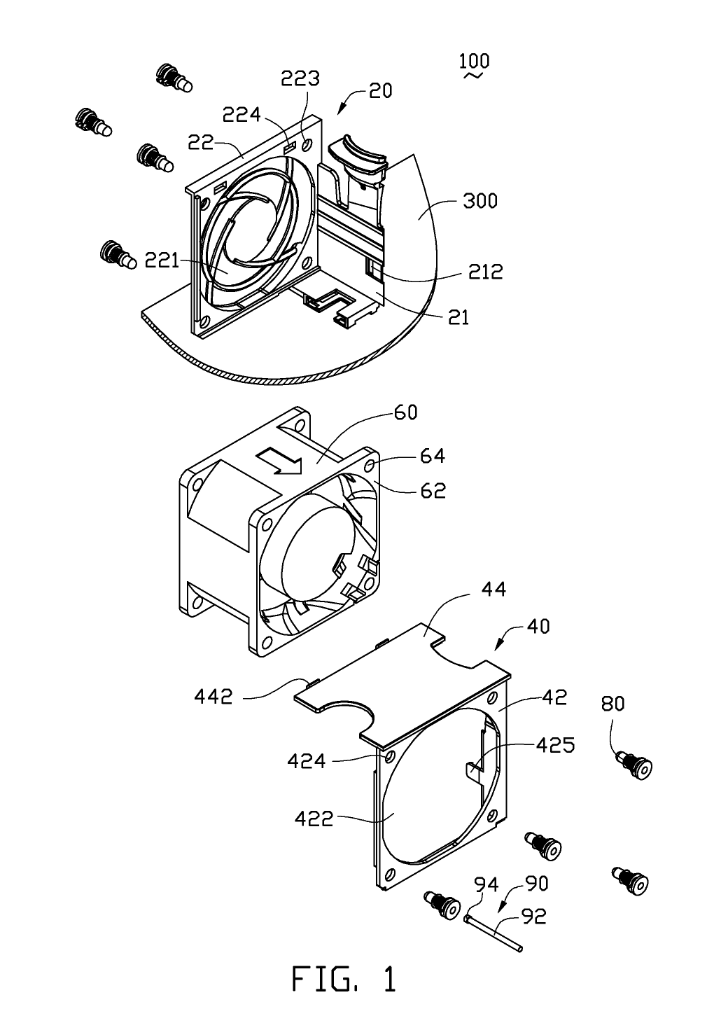

FIG. 1 shows an exemplary embodiment of a fastening device 100 for mounting a fan 60. The fastening device 100 includes a bracket 20 mounted on a base 300, a shell 40, a plurality of fasteners 80, and an operation pole 90.

The bracket 20 includes a substantially L-shaped mounting plate 21 mounted on the base 300, and a rectangular supporting plate 22 perpendicularly extending out from a side of the mounting plate 21 and connected to the base 300. The mounting plate 21 defines a latching hole 212 away from the supporting plate 22. A middle of the supporting plate 22 defines a plurality of vents 221. Four corners of the supporting plate 22 define four installation holes 223. An upper portion of the supporting plate 22 defines two latching holes 224, between the upper installation holes 223.

The shell 40 includes a rectangular connecting plate 42 and a latching plate 44 perpendicularly extending out from a top of the latching plate 44. The connecting plate 42 defines an opening 422 in a middle of the connecting plate 42, and four connecting holes 424 in four corners of the connecting plate 42. A hook 425 perpendicularly extends out from a side of the connecting plate 42. Two hooks 442 protrude out from a side of the latching plate 44 away from the connecting plate 42.

The fan 60 includes two opposite and rectangular side plates 62. Each side plate 62 defines four positioning holes 64 in four corners of the side plate 62.

The operation pole 90 includes an operation portion 92 and a head 94 protruding out from an end of the operation portion 92.

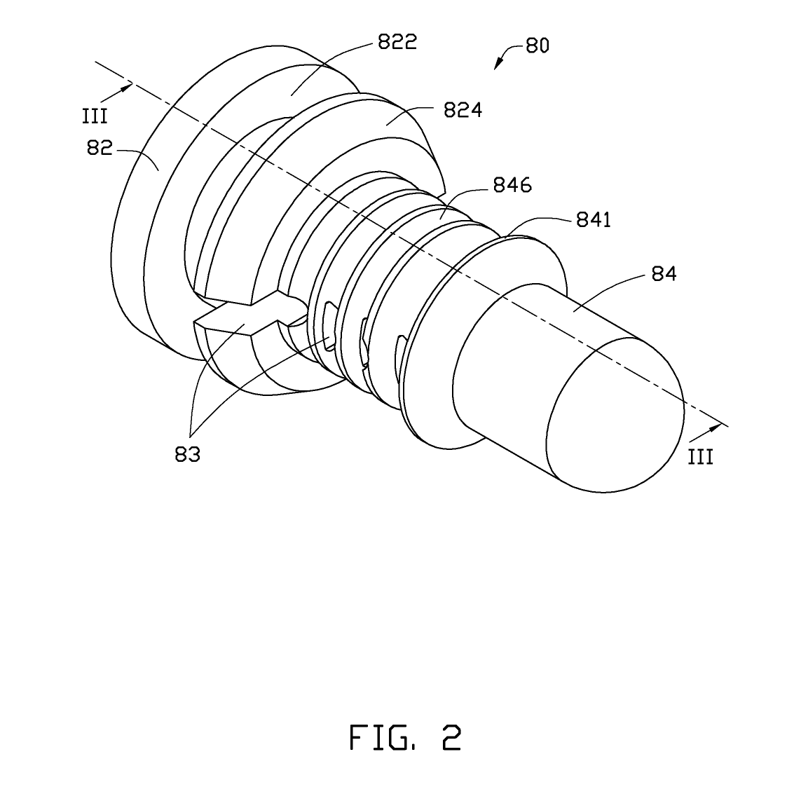

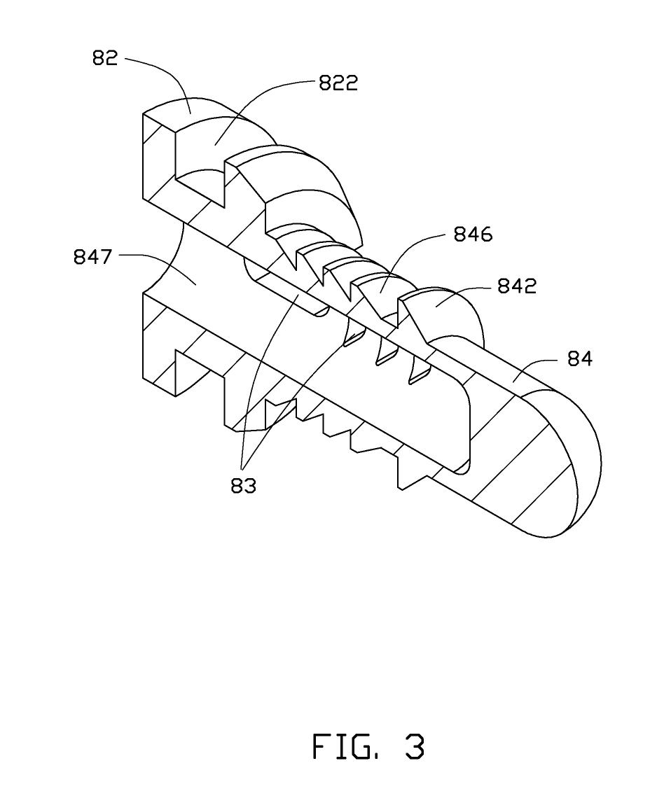

FIGS. 2 and 3 show one of the fasteners 80. The fastener 80 is made of resilient material, such as pliable plastic. The fastener 80 includes a cylindrical head 82, and a cylindrical position pole 84 perpendicularly extending out from a first end of the head 82. A circumference of the head 82 defines an annular mounting slot 822. The first end of the head 82 defines a tapered guiding surface 824 facing the positioning pole 84. An annular resilient latching portion 841 perpendicularly extends out from the positioning pole 84 away from the head 82. A plurality of annular resilient protrusions 846 perpendicularly protrudes out from the positioning pole 84, between the head 82 and the latching portion 841. A side of the latching portion 841 away from the head 82 defines a tapered guiding surface 842. A second end of the head 82 opposite to the positioning pole 84 axially defines an operation hole 847 extending to the positioning pole 84. The circumference of the head 82 defines a plurality of through holes 83 communicating with the operation hole 847, and the protrusions 846 define a plurality of through holes 83 communicating with the operation hole 847, for facilitating deforming the protrusions 846. A distal end of the position pole 84 is hemispherical.

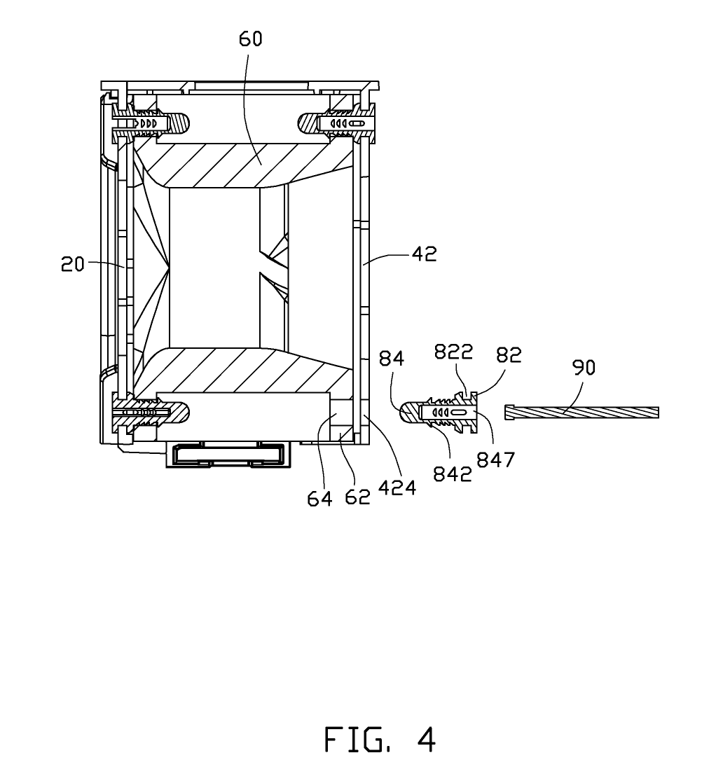

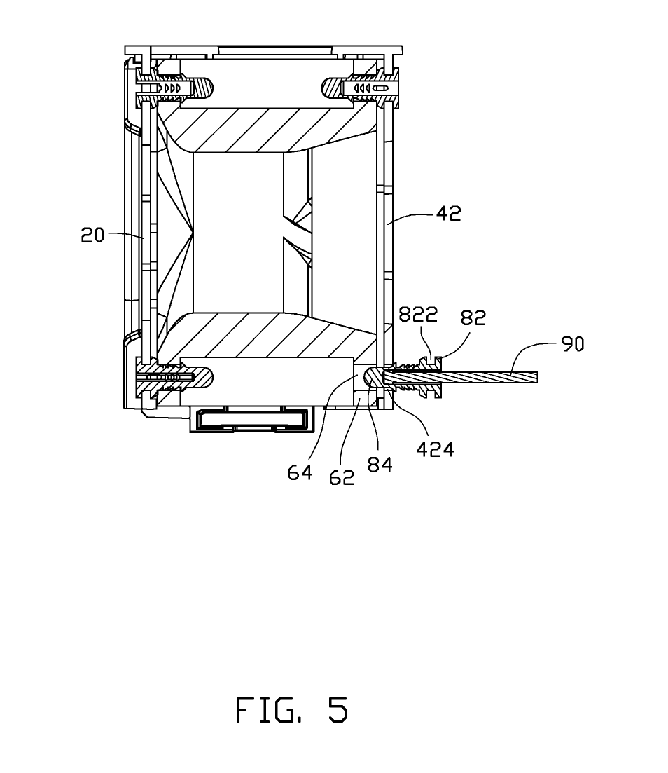

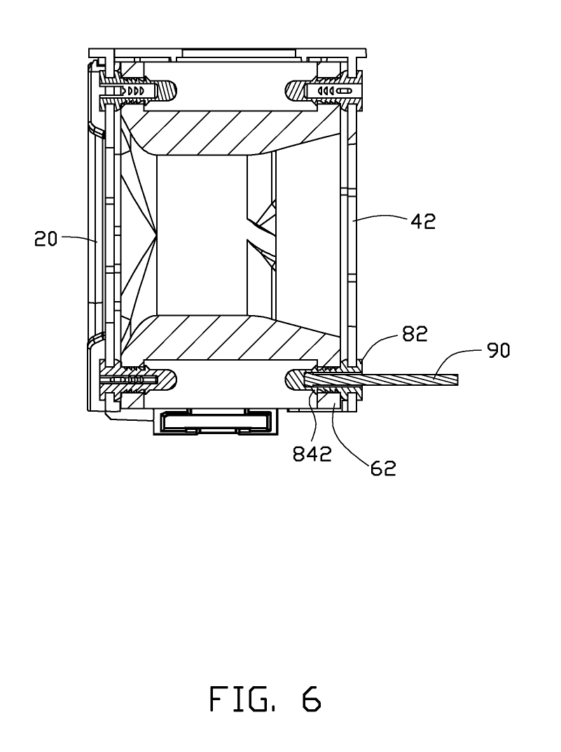

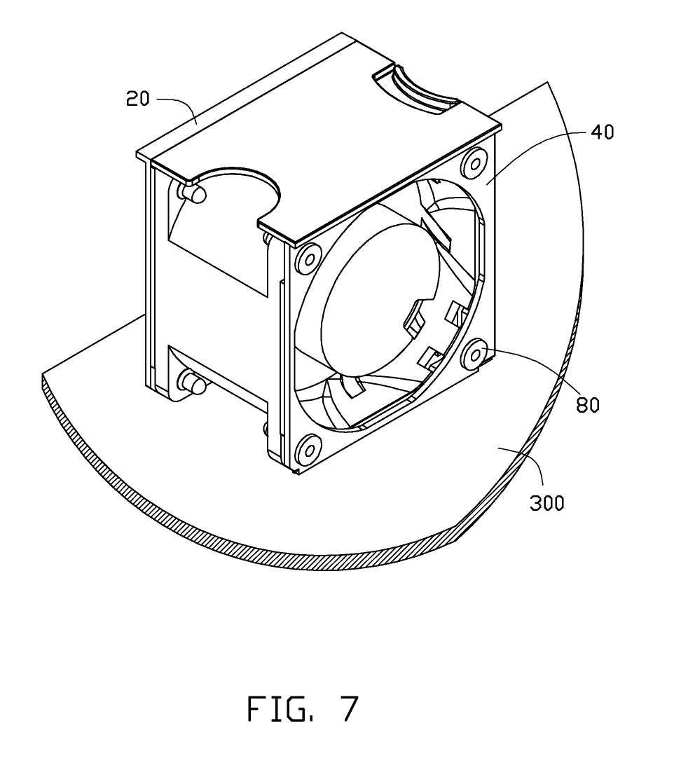

FIGS. 4-7 show assembling the fan 60. The fan 60 is received in the bracket 20, with the positioning holes 64 of one of the side plates 62 aligning with the installation holes 223. The hooks 442 and 425 of the shell 40 are inserted into the latching holes 224 and 212. The fan 60 is sandwiched between the supporting plate 22 and the connecting plate 42, with the positioning holes 64 of the other side plate 62 aligning with the connecting holes 424 of the connecting plate 42.

The operation portion 92 of the operation pole 90 is operated, to allow the head 94 of the operation pole 90 to be inserted into the operation hole 847 of one of the fasteners 80. The position pole 84 of the fastener 80 is inserted into one of the installation holes 223 of the bracket 20 and the corresponding positioning hole 64 of the one of the side plates 62 of the fan 60. The guiding surface 842 of the fastener 80 is slidably abutted against a sidewall bounding the corresponding positioning hole 64. In addition, and the guiding surface 824 the fastener 80 is slidably abutted against a sidewall bounding the corresponding installation hole 223, deforming the latching portion 841 and the head 82, until the latching portion 841 passes through the positioning hole 64 and the sidewall bounding the installation hole 223 engages in the mounting slot 822. The latching portion 841 of the fastener 80 is restored to abut against an inner surface of the one of the side plates 62, and the head 82 is restored to allow the supporting plate 22 surrounding the installation hole 223 to latch in the corresponding mounting slot 822. Three of the fasteners 80 are installed by the same means mentioned above.

The operation portion 92 of the operation pole 90 is operated, to allow the head 94 of the operation pole 90 to be inserted into the operation hole 847 of one of the fasteners 80. The position pole 84 of the fastener 80 is inserted into one of the connecting holes 424 of the shell 40 and the corresponding positioning hole 64 of the other side plates 62 of the fan 60. The guiding surface 842 of the fastener 80 is slidably abutted against a sidewall bounding the corresponding positioning hole 64. In addition, the guiding surface 824 of the fastener 80 is slidably abutted against a sidewall bounding the corresponding connecting hole 424, deforming the latching portion 841 and the head 82, until the latching portion 841 passes through the positioning hole 64 and the sidewall bounding the connecting hole 424 engages in the mounting slot 822. The latching portion 841 of the fastener 80 is restored to abut against an inner surface of the other side plates 62, and the head 82 is restored to allow the connecting plate 42 surrounding the connecting hole 424 to latch in the mounting slot 822. Three of the fasteners 80 are installed by the same means mentioned above.

The resilient protrusion 846 of each fastener 80 is resiliently abutted against the sidewall bounding the corresponding positioning hole 64 of the fan 60. During operation, the size of the through hole 83 of each fastener 80 is changed, vibration transferred among the fan 60, the bracket 20, and the shell 40 is reduced.

While the disclosure describes examples and embodiments, it is to be understood that the disclosure is not limited thereto. To the contrary, the disclosure is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A fastener, comprising:
a resilient head defining an annular mounting slot in a circumference of the head;
a position pole extending out from a first end of the head; and
a resilient latching portion extending out from a circumference of the position pole away from the head, wherein a second end of the head opposite to the position pole defines an operation hole extending to the position pole.

2. The fastener of claim 1, wherein the head is cylindrical, the operation hole is axially defined in the head.

3. The fastener of claim 2, wherein the first end of the head surrounding the position pole defines a tapered guiding surface.

4. The fastener of claim 2, wherein a side of the latching portion away from the head defines a tapered guiding surface.

5. The fastener of claim 1, wherein a plurality of resilient protrusions protrudes out from the position pole, between the head and the latching portion.

6. The fastener of claim 5, wherein the plurality of protrusions defines a plurality of through holes communicating with the operation hole.

7. The fastener of claim 1, wherein the circumference of the head defines a plurality of through holes communicating with the operation hole.

8. The fastener of claim 1, wherein the fastener is made of resilient material.

9. A fastening device for mounting a fan with two opposite side plates each defining a plurality of positioning holes, comprising:
a bracket comprising a supporting plate defining a plurality of installation holes;
a plurality of fasteners each comprising a resilient head, a position pole extending out from a first end of the head, and a resilient latching portion protruding out from the position pole away from the head;
wherein the resilient head of each fastener defines an annular mounting slot in a circumference of the head, a second end of the head opposite to the position pole defines an operation hole extending to the position pole, the fan is received in the bracket, with the positioning holes of one of the side plates of the fan aligning with the installation holes of the supporting plate, an operation pole is inserted into the operation hole of each fastener, the position pole of the fastener is inserted into a corresponding installation hole of the supporting plate and the corresponding positioning hole of the fan, deforming the latching portion and the head, until the latching portion extends through the positioning hole and a sidewall bounding the installation hole engages in the mounting hole, the latching portion is restored to abut against an inner surface of the one of the side plates of the fan, and the head is restored to allow the supporting plate to latch in the mounting slot of the fastener.

10. The fastening device of claim 9, further comprising a shell mounted to the bracket, wherein the shell comprises a connecting plate mounted to the other side plate of the fan opposite to the supporting plate.

11. The fastening device of claim 10, wherein the supporting plate defines a latching hole, a hook protrudes out from the shell, to be latched into the latching hole of the bracket.

12. The fastening device of claim 10, wherein the connecting plate defines a plurality of connecting holes aligning with the positioning holes of the other side plate of the fan, a corresponding position pole of the fastener is inserted into a connecting hole of the connecting plate and the corresponding positioning hole of the fan, deforming the latching portion and the head, until the latching portion extends through the positioning hole and a sidewall bounding the connecting hole aligns with the mounting slot, the latching portion is restored to abut against an inner surface of the other side plate of the fan, and the head is restored to allow the connecting plate to latch in the mounting slot of the fastener.

13. The fastening device of claim 9, wherein the head is cylindrical, the operation hole is axially defined in the head.

14. The fastening device of claim 13, wherein the first end of the head adjacent to the position pole defines a tapered guiding surface.

15. The fastening device of claim 13, wherein a side of the latching portion away from the head defines a tapered guiding surface.

16. The fastening device of claim 9, wherein a plurality of resilient protrusions protrudes out from the position pole, between the head and the latching portion.

17. The fastening device of claim 16, wherein the plurality of protrusions define a plurality of through holes communicating with the operation hole.

18. The fastening device of claim 9, wherein the circumference of the head defines a plurality of through holes communicating with the operation hole.

19. The fastening device of claim 9, wherein the head and the latching portion are made of resilient material.
